(19) United States
(12) Patent Application Publication
(10) Pub. No.: US 2024/0062436 A1
(43) Pub. Date: Feb. 22, 2024

(54) USING STABLE DIFFUSION TO PRODUCE IMAGES CONFORMING TO COLOR PALETTE

(71) Applicant: Sony Interactive Entertainment LLC, San Mateo, CA (US)

(72) Inventor: Sophia Zalewski, San Mateo, CA (US)

(21) Appl. No.: 18/483,207

(22) Filed: Oct. 9, 2023

(51) Int. Cl. G06T 11/00

(52) U.S. Cl. CPC G06T 11/001

(57) ABSTRACT

Techniques are described for generating images such as but not limited to custom team emblems using stable diffusion (SD) based on input text describing a desired image. A pixelated multi-color palette with an optional guidance image is input to a SD model to achieve a desired target color for an image generated in response to a short text input description. The optional guidance image may be used for more accurate output images in terms of conforming to the desired foreground object and permit the use of lower strength values.

### FIELD

The present application relates to technically inventive, non-routine solutions that are necessarily rooted in computer technology and that produce concrete technical improvements, and more specifically to using generative networks to produce images with colors conforming to input.

### BACKGROUND

Generative AI is a general term that refers to a type of neural network such as a large language model (LLM) such as a generative pre-trained transformer (GPTT) that can generate comparatively complex output based on comparatively terse input. An example of a LLM from the multi-domain realm is stable diffusion, which employs a series of neural networks to generate images from one or a few input words describing the desired image. As understood herein, improvements to stable diffusion are possible.

### SUMMARY

As understood herein and with more particularity, the color palette of an image produced by stable diffusion (SD) may precisely match a desired palette of the desired image. As an example, it may desirable to generate custom in-game icons and emblems for a computer simulation such as a computer game based on different team colors, essentially meaning that SD should be fine-tuned for emblem generation.

Accordingly, an apparatus includes at least one processor assembly configured to input color palette representation as an input image with a strength parameter to a stable diffusion (SD) model. The color palette representation includes at least two colors. The processor assembly is configured to input text to the SD model, and present an image output by the SD model responsive to the input text conforming to the input color palette.

In example embodiments the processor assembly can be configured to establish the input color palette representation at least in part by converting a blocked color palette into a smaller pixelated patch color palette representation. In these embodiments the processor assembly can be configured to convert the blocked color palette into the color palette representation at least in part by sampling a random pixel in the blocked color palette for every pixel in the color palette representation being created to create a random patch of colors with no spatial dependencies.

In some examples, the color palette representation can include a 16×16 pixelated “patch” color palette. The color palette representation can have a resolution of at least four pixels. Thus, the color palette representation can have a resolution of at least eight pixels by eight pixels. In some examples, the color palette representation has a resolution of no more than one hundred twenty eight by one hundred twenty eight (128×128) pixels.

The strength parameter may be at least 0.9. The strength parameter establishes how far the output image from the SD model varies from an input image, with higher strength indicating higher deviation.

In example implementations the processor assembly can be configured to add to the input color palette at least one line of an image of an object produce images to appear visually similar to the object in the image with a color correlated to the input color palette.

In another aspect, a method includes training a stable diffusion (SD) model to produce images in at least one desired color at least in part by inputting to the SD model a patch representation of an input color palette, with the patch representation having a resolution of between 8×8 and 256×256 pixels. The method includes inputting to the SD model along with the patch representation at least a portion of a guidance image, and using a strength value is between 0.9 and 1. The method includes presenting an image output by the SD model at least in part responsive to the patch representation, portion of the guidance image, and strength value.

In another aspect, an apparatus includes at least one computer medium that is not a transitory signal and that in turn includes instructions executable by at least one processor assembly to input color representation as an input to a stable diffusion (SD) model. The instructions are executable to receive input text to the SD model, and present an image output by the SD model responsive to the input text conforming to the input color.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates example logic in example flow chart format consistent with present principles;

FIG. 3 illustrates an example blocked color palette with resulting images;

FIG. 4 illustrates an example pixelated patch color palette representation with resulting images;

FIG. 5 illustrates three example pixelated patch color palette representations;

FIG. 6 illustrates addition of a guidance image or portion thereof to example color palettes;

FIG. 7 illustrates a guidance image line to be input with color palettes to render respective images at respective strengths;

FIG. 8 illustrates alternate example logic in example flow chart format;

FIG. 9 illustrates a guidance image consistent with FIG. 8;

FIG. 10 illustrates operation on the image of FIG. 9;

FIG. 11 illustrates another example guidance image; and

FIG. 12 illustrates operation on the image of FIG. 11.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

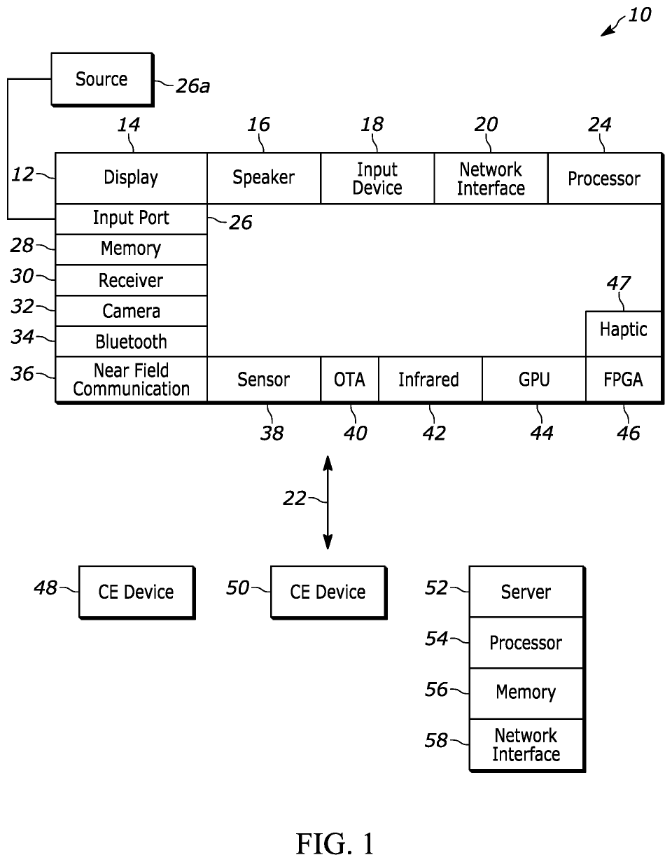

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as generative pre-trained transformers (GPTT) and stable diffusion (SD) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

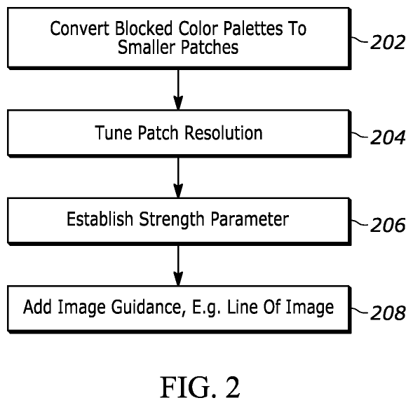

Refer now to FIG. 2 for an overall understanding of a first example of present techniques. In the first example, a pixelated multi-color palette with an optional guidance image is input to a SD model to achieve a desired target color for an image generated in response to a short text input description. The optional guidance image may be used for more accurate output images in terms of conforming to the desired foreground object and permit the use of lower strength values.

Commencing at state 202, to condition the SD model on a target color scheme, a multi-color palette representation can be established that represents a desired primary target color and one or more background colors. The color palette representation may be used as an input image to img2img stable diffusion with a very high strength parameter (e.g., greater than 0.9). The resulting output images tend to follow the color scheme of the original palette input.

While inputting blocked color palettes into img2img with high strength (e.g., 0.99, to follow the input image less closely) returns effective results in terms of output color, as indicated at state 202 a blocked color pattern is converted to smaller pixelated color patch palettes to better obviate distinct spatial patterns in the input image.

The size of these patches may range from four pixels by four pixels to one hundred fifty six to one hundred fifty six pixels in some embodiments, although other embodiments may use patches of different sizes. In an example, a pixelated color patch palette may be sixteen pixels by sixteen pixels.

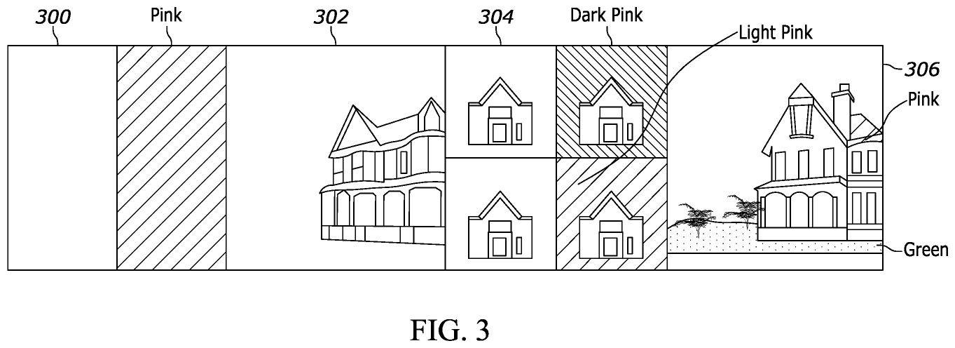

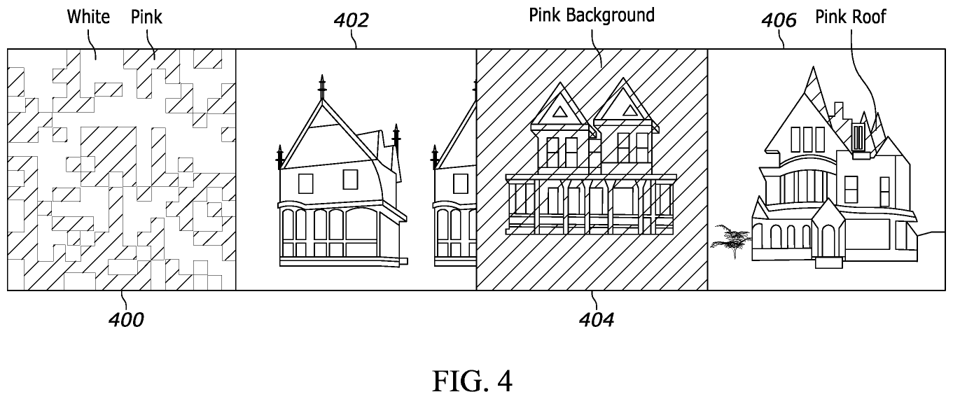

Referring briefly to FIGS. 3 and 4, in FIG. 3 input of a “blocked” color palette 300 consisting of a white stripe next to a pink stripe in the non-limiting example causes the SD model to generate, in response to a prompt “a cute Victorian house photorealistic” with a strength=0.99 and with respective seeds=[0,1,2,3], respective pink and white images 302, 304, 306 of a house with colors noted on the Figure.

In FIG. 4, however, input of a pixelated color patch palette 400 to the SD model with the same prompt, strength, and seeds causes the SD model to generate respective images 402, 404, 406 with noted colors in the Figure.

Pixelated patches produce better outputs, while blocked palettes may cause resulting images to match the semantic format of the input too closely. However, either may be used consistent with present principles.

In one example technique, to produce a color patch palette from a “blocked” representation, a random pixel in the blocked palette may be sampled for every pixel in the patched palette being created. This generates a random “patch” of colors with no spatial dependencies, but still contains the colors in the palette in their corresponding ratios. Non-limiting example code for this technique may be:

```
# Pixelates a given color palette
def palette_to_palette(palette, chunks=16):
  width,height = palette.size
  pixels = palette.load( )
  new_palette = Image.new(mode=“RGB”, size=(chunks, chunks))
  new_pixels = new_palette.load( )
  for i in range(chunks):
    for j in range(chunks):
      x = random.randrange(width)
      y = random.randrange(height)
      new_pixels[i,j] = pixels[x,y]
  return new_palette.resize((512,512),resample
```

Returning to FIG. 2, at state 204 patch resolution may be tuned. Because palette patches display the necessity for the input image to look somewhat random, the next logical step is to determine what resolution of pixelation produces the best results. Any dimension of pixelated input palettes containing at least four pixels was capable of providing a sufficiently random sample to produce outputs without any spatial dependencies on the input palette given a high strength parameter. In example implementations, palette patches with greater than eight by eight (8×8) pixels are preferred. With more pixels the output image generated by the SD model has a more fine-grained output although a patch with 512×512 pixels produces outputs that look highly granulated like a newspaper image, so, palettes with pixelated resolutions anywhere in the range of eight by eight (8×8) to one hundred twenty eight by one hundred twenty eight (128×128) are preferred.

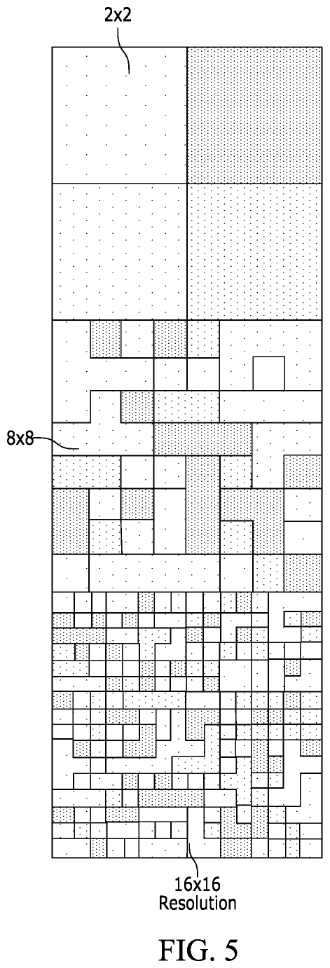

FIG. 5 illustrates color palette patch “resolution” (with resulting example images omitted) for resolutions [2×2, 8×8, 16×16], prompt=“a cute Victorian house photorealistic”, strength=0.99, seeds=[0,1,2,3].

Note that because palette patches are created somewhat randomly, output figures of images with palette patches created from the same blocked palette representation (which are slightly different each time due to randomness) may be produced. The slight differences in the palette patches produce slightly different outputs even for the same random seed in the stable diffusion generator, meaning the pixelated palette acts as a second random “seed” that slightly influences the output image.

Moving to state 206 of FIG. 2, the strength parameter noted above may be established. Any “strength” value less than 0.9 in the stable diffusion pipeline tends to produce results that too closely resemble the input palette, although such strength values under 0.9 may be used.

Proceeding to state 208 of FIG. 2, to generate high quality output with a lower strength value (following closer to the palette), the line embedding of a relevant image may be added to the input palette as image guidance. This technique allows images to appear visually similar to the guidance image, but in the correct user-specified palette.

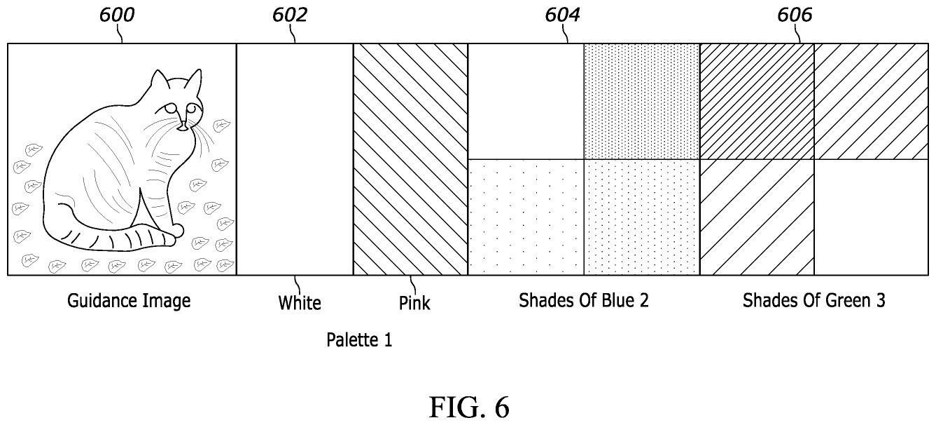

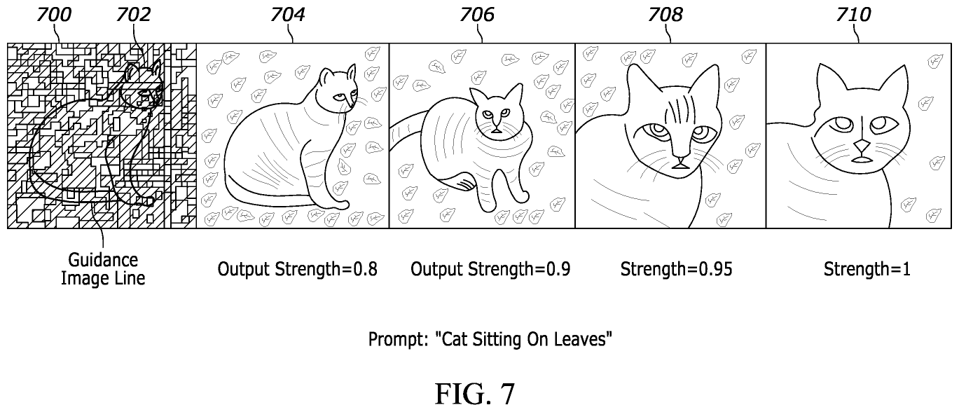

FIG. 6 illustrates. To illustrate, portions of a guidance image 600, in this case, of a cat, is shown for combining with any one of three target color palettes 602, 604, 606 and input to the SD model. FIG. 7 illustrates in greater detail. A pixelated palette 700 with embedded cat image line 702 is used as input to a SD model along with the prompt “cat sitting on leaves” to cause the SD model to generate respective output images 704, 706, 708, 710 for respective strength values 0.8 to 1.

Accordingly, in example implementations an input palette produces best results with a “patch” representation and resolution of between 8×8 and 256×256 pixels, plus a guidance image outline embedding. A strength value of between 0.9 and 1 may be used, depending on the palette and the text prompt describing the desired image. Palette patches act as an added random seed that slightly influences minute details in the output image.

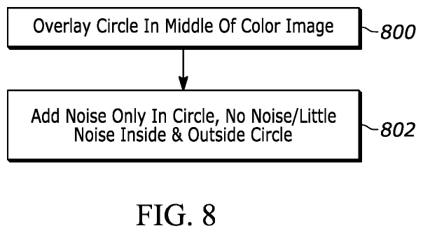

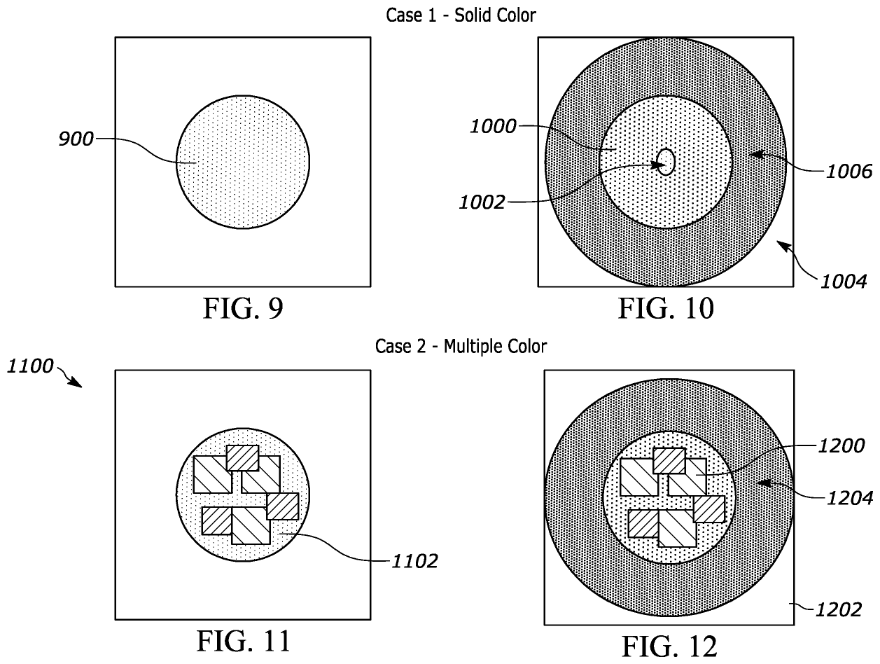

FIGS. 8 and 9 illustrate a second example of present techniques. Because one example use-case for color palette-conditioned stable diffusion is generating custom in-game icons and emblems based on different team colors, it is important that this method works functionally on a stable diffusion model fine-tuned for emblem generation. To generate custom team emblems with this method, as indicated at state 800 in FIG. 8 and as illustrated in FIG. 9, an enclosed shape such as a triangle, rectangle, or, in the example shown, a circle 902 may be overlaid in the center of a pure-color background or pixelated multi-color background 900 representing each team's “color” and used as the input to stable diffusion img2img given a fine-tuned U-net to produce emblems to produce high-quality emblem outputs that generally match the input color.

Whereas in the first technique illustrated in FIG. 2 and related figures a pixelated color palette is used to which noise is added uniformly and then removed with background removal, in the second technique of FIGS. 8 and 9 a guidance image in the form of the shape such as a circle or ring 900 is provided (state 800 in FIG. 8) in the foreground in a first color with a second, contrasting background color 902. In the example of FIG. 9, the foreground 900 is a solid circle of a desired color, e.g., yellow, whereas the background 902 is a different color, e.g., blue. In this technique, as indicated at state 802 in FIG. 8 noise is added within the shape (in FIG. 9, within a circular donut formed by the outer part of the foreground 900 but not in the center of the foreground)). The noise added inside the “donut” forces output colors to match input colors of the image shown in FIG. 9 for producing, using the SD model, emblems such as team emblems. FIG. 10 illustrates that noise is added to a donut 1000 formed by the foreground 900 of FIG. 9 but not in a central small disk 1002 of the foreground so that the color in the small disk 1002 will remain unchanged in the final output image. Areas 1004 of the background are not “noised” and so the background color there will remain unchanged in the final output image. Moreover, noise may be added to a region 1006 of the background surrounding the donut 1000 of the foreground, so that the Asd model will fill in the “noised” 1000, 1006 areas to conform to the input text prompt.

The SD model then removes the noise within the inner and outer boundaries of the donut-shaped rings 1000, 1006. Then, in a postprocess step the background, i.e., the portion of the image outside the outer boundary of the circle 902, is removed to render a resulting image that represents centered emblems in the target color within the circle with the background removed.

Combinations of the techniques herein may be used. For example, instead of a pure color background 900, the second technique may use a multi-color pixelated background established using all or portions of the first method of FIG. 2.

FIGS. 11 and 12 illustrate an alternate guidance image 1100 that uses, within a foreground circle 1102, a multiple colored palette with pixelated colors inside the circle only (where noise is implemented on them as shown in FIG. 12 at 1200), with no noise in edges 1202 of the background. Noise is added within the foreground 1102 and a donut 1204 around the foreground so the output image will conform to the text prompt. The resulting image would still contain that pixelization in the noised areas and the colors of the noised areas will still somewhat match the colors within the foreground 1102 of FIG. 11.

While particular techniques are herein shown and described in detail, it is to be understood that the subject matter which is encompassed by the present application is limited only by the claims.

What is claimed is:

1. An apparatus comprising:
at least one processor assembly configured to:
input color palette representation as an input image with a strength parameter to a stable diffusion (SD) model;
input text to the SD model; and
present an image output by the SD model responsive to the input text conforming to the input color palette.

2. The apparatus of claim 1, wherein the processor assembly is configured to:
establish the input color palette representation at least in part by converting a blocked color palette into a smaller pixelated patch color palette representation.

3. The apparatus of claim 1, wherein the color palette representation comprises a 16×16 pixelated “patch” color palette.

4. The apparatus of claim 2, wherein the processor assembly is configured to:
convert the blocked color palette into the color palette representation at least in part by sampling a random pixel in the blocked color palette for every pixel in the color palette representation being created to create a random patch of colors with no spatial dependencies.

5. The apparatus of claim 1, wherein the color palette representation has a resolution of at least four pixels.

6. The apparatus of claim 1, wherein the color palette representation has a resolution of at least eight pixels by eight pixels.

7. The apparatus of claim 6, wherein the color palette representation has a resolution of no more than one hundred twenty eight by one hundred twenty eight (128×128) pixels.

8. The apparatus of claim 1, wherein the strength parameter is at least 0.9.

9. The apparatus of claim 1, wherein the processor assembly is configured to:
add to the input color palette at least one line of an image of an object produce images to appear visually similar to the object in the image with a color correlated to the input color palette.

10. The apparatus of claim 1, wherein the image comprises an emblem.

11. A method comprising:
training a stable diffusion (SD) model to produce images in at least one desired color at least in part by:
inputting to the SD model a patch representation of an input color palette, the patch representation having a resolution of between 8×8 and 256×256 pixels;
inputting to the SD model along with the patch representation at least a portion of a guidance image;
using a strength value is between 0.9 and 1; and
presenting an image output by the SD model at least in part responsive to the patch representation, portion of the guidance image, and strength value.

12. The method of claim 11, wherein the image comprises an emblem.

13. An apparatus comprising:
at least one computer medium that is not a transitory signal and that comprises instructions executable by at least one processor assembly to:
input color representation as an input to a stable diffusion (SD) model;
receive input text to the SD model; and
present an image output by the SD model responsive to the input text conforming to the input color.

14. The apparatus of claim 13, wherein the instructions are executable to:
establish the color representation at least in part by converting a blocked color palette into a pixelated patch color palette representation.

15. The apparatus of claim 13, wherein the color representation comprises a 16×16 pixelated “patch” color palette.

16. The apparatus of claim 14, wherein the instructions are executable to:
convert the blocked color palette into the color representation at least in part by sampling a random pixel in the blocked color palette for every pixel in the color representation being created to create a random patch of colors.

17. The apparatus of claim 13, wherein the color representation has a resolution of at least four pixels and no more than one hundred twenty eight by one hundred twenty eight (128×128) pixels.

18. The apparatus of claim 13, wherein the instructions are executable to input to the SD model along with the color representation a strength parameter of at least 0.9.

19. The apparatus of claim 13, wherein the instructions are executable to:
add to the input color representation at least one line of an image of an object.
